(19) United States
(12) Patent Application Publication
(10) Pub. No.: US 2006/0173721 A1
(43) Pub. Date: Aug. 3, 2006

(54) Computer-based transportation-safety system

(76) Inventor: Jerry E. Gregg, Overland Park, KS (US)

Correspondence Address: SHOOK, HARDY & BACON LLP;INTELLECTUAL PROPERTY DEPARTMENT, 2555 GRAND BLVD, KANSAS CITY,, MO, 64108-2613, US

(21) Appl. No.: 11/049,117

(22) Filed: Feb. 2, 2005

(51) Int. Cl. G06F 17/60

(52) U.S. Cl. 705/6; 705/13

(57) ABSTRACT

Disclosed is a transportation safety system which is used to identify potential dangers surrounding shipments of goods and/or humans. The system is automated. Initially, the shipment is inspected. The inspection involves the use of digital sensors (e.g., visual, audio, olfactory, chemical) which are used to create an electronic fingerprint which includes the digital readings taken. The fingerprint includes information regarding the cargo and the vehicle. The fingerprint is maintained in a database which is accessible by interested organizations, such as the FBI, port authority, inter alia. The system also utilizes detection points. These detection points take new digital readings. These new readings are then compared with the fingerprint to determine whether dangers exist.

### CROSS-REFERENCE TO RELATED APPLICATIONS

None.

### STATEMENT REGARDING FEDERALLY SPONSORED RESEARCH OR DEVELOPMENT

None.

### BACKGROUND OF THE INVENTION

1. Field of the Invention

The invention relates to safety in the transportation of things or persons. More specifically, the invention relates to security systems for goods and/or humans and the vehicles used to transport them.

2. Description of the Related Art

Once a purchase order is received by a manufacturer or other vendor, the manufacturer will prepare what is known as a bill of lading (“BOL”) which will be submitted to a mode of transportation (“MOT”). The MOT takes the BOL and acts on it to ship the product to the customer of the manufacturer. Thus, the BOL is associated with a particular shipment and is essentially a written receipt from a carrier company. The receipt recites that that carrier has received the specific goods included in that shipment for delivery to a particular destination which is the location of the customer. These written recitations also include detailed information regarding the cargo. They describe precise contents, as well as quantities, with respect to the payload. If any hazardous cargo is included, the BOL will note this.

Traditionally, BOL's have been maintained manually using paperwork. With the advent of computers, however, these documents have been increasingly stored and maintained electronically. These electronic BOL's have been maintained as separate documents, or separate groups of documents maintained on computing systems.

Though safety has always been a concern with respect to the shipping and transportation industries, the focus (before recently) has been on the financial aspects of the process. For example, shippers tended to be more concerned with quick, reliable, and accurate service than other concerns, such as safety and security. Another area of focused-on goal in the past systems has been the avoidance of unnecessary paperwork or “red tape” associated with the shipping process. The goal being to make the process more unencumbered.

Recently, there has been a shift in emphasis. These traditional concerns have been somewhat mitigated by the present environment in which safety is a major issue. Particularly in view of recent acts of terrorism, the safety issue has been moved to the forefront. Some of the dangers for which the level of concern has been elevated are: the management of dangerous chemicals, the transportation of illegal aliens across our borders, defects in the transportation equipment, and the prevention of acts of terrorism (e.g., the transfer of biohazardous materials such as Anthrax or other terrorists-concocted biological weapons, nuclear weapons).

Because of these recently-emphasized concerns, there is a need in the art for a new sort of transportation monitoring system. It is desirable that this system be able to detect dangerous chemicals, the presence of illegal aliens, and defects in the vehicles' equipment. It is also desirable that this new system be able to prevent acts of terrorism. Further, it is important that the new system be able to adequately meet these new security needs without further encumbering the process.

### SUMMARY OF THE INVENTION

The present invention is a transportation safety system. It includes one or more computer-readable media, having computer-usable instructions embodied thereon for performing a method. The method comprises first receiving an original data set. This original data from a client. The client may be a shipper. This original data set, referred to here later as a “fingerprint” includes information regarding a transportation shipment being made from an original location by a transportation vehicle. The original data set is maintained in a database which is accessible by interested organizations, such as the FBI, port authority, inter alia.

The process also involves receiving new data from at least one sensor, but most likely a plurality of sensors, at detection-point location. Once the sensed information is received, the newly-sensed data is compared with the original data set, which includes all the originally-collected data. In view of the comparison, a determination is made between the original set and the newly-sensed set. This comparison may reveal dangers. For example, it could reveal that hazardous cargo has been leaked. In such a case, the system automatically notifies the interested entity.

### BRIEF DESCRIPTION OF THE SEVERAL VIEWS OF THE DRAWINGS

The present invention is described in detail below with reference to the attached drawing figures, wherein:

FIG. 1 is the schematic representation of one embodiment of the present invention showing the system components of the transportation safety system (TSS).

FIG. 2 is a schematic and geographical representation showing how one embodiment of the present invention can be incorporated to protect a geographic area.

FIG. 3 is a geographical representation of the United States showing border controlled areas, points of entry, and detection points as might be employed in one embodiment of the present invention.

FIG. 4 is a process diagram showing one embodiment of the present invention in which the TSS application might be used.

FIG. 5 is a flow diagram showing how a shipment is introduced into the transportation safety system application of the present invention.

FIG. 6 is a flow diagram showing how the TSS system of the present invention processes work when a shipment reaches a checkpoint in the system and is evaluated for security and other purposes.

### DETAILED DESCRIPTION OF THE INVENTION

The present invention provides a system and method for thoroughly and constantly monitoring all of the transportation activity (commercial shipments and other transportation activities) within a particular geographic location, or perhaps a plurality of sub-locations included in a more generic substantially inclusive area. Ideally, the entire world. But initially, the system would be useful for more geographically limited applications. For example, it could be implemented for the transportation systems for a particular state, or for the entire United States.

Through automation, the system is used to generate a fingerprint. The fingerprint will be used as a shipment identifier in a similar manner for which actual human fingerprints are used by a law enforcement agencies to identify humans.

Here, an electronically generated fingerprint will be used to identify the characteristics of a shipment. The fingerprint will be maintained, updated, and referenced for security and safety purposes. This fingerprint will include information which is sensed electronically from the shipment. The fingerprint may also include data from a historical data base, the shipper generated BOL, and sensed data.

The database is included in a broad sweeping computing system. This system uses the fingerprint to identify any suspicious changes in the status of a particular shipment. For example, in one aspect of the invention, this stored fingerprint, which includes the particular data regarding weight, content, and other information regarding the shipment, can be used to compare to actual readings taken at different checkpoints along the way during the transport of the shipment. Any unusual disparities from the fingerprint detected by the sensing/checkpoint system will trigger electronic alarms. These alarms result in the immediate notification of the proper transportation authority, e.g., FBI, Port Authority.

In another aspect of the invention, alarms may be triggered regardless of any record. There are some things which, when presented to the system, will be in of themselves indicative of trouble without requiring comparison to the fingerprint. The system will be able to detect by sound, smell, or other electronically perceptible sense mechanical defects within the transportation equipment itself. For example, the wheel bearings on a railroad car may produce a readable output that portents a future danger, i.e., the wheel bearings are beginning to fail an have a limited time before a catastrophic failure occurs. Thus, significant harm can be avoided if this is electronically detected well in advance of failure so that appropriate repairs can be made and possibly even lives be spared. And you do not have to reference the fingerprint information to know that this is a situation which requires immediate dealing. Fingerprint comparison of the readable output might, however, be advantageous in making a sound comparison, however. Another example might be a subtle sound occurring in the gas turbine of an airplane's engine. Sensors might be able to detect this sound well in advance of failure, averting potential disaster.

Because the entire system is completely automated, it is essentially error-free (unless those errors are injected by human interfacing or the rare case of hardware failure) and incredibly fast. Speed is, of course, imperative if the intent is to avoid an act of terrorism or some other unforeseen problem. This makes the present invention an ideal defender.

Various technical terms are used throughout this description. These definitions are intended to provide a clearer understanding of the ideas disclosed herein but are in no way intended to limit the scope of the present invention. The definitions and terms should be interpreted broadly and liberally to the extent allowed the meaning of the words offered in the above-cited reference. For example, whereas some distinguish the World Wide Web (WWW) as a subcomponent of the Internet, “web”—as used herein—should not be construed as limited to the WWW. Rather, “web” is intended to refer generally to the Internet and/or is related subnetworks and subcomponents.

As one skilled in the art will appreciate, the present invention may be embodied as, among other things: a method, system, or computer-program product. Accordingly, the present invention may take the form of a hardware embodiment, a software embodiment, or an embodiment combining software and hardware. In a preferred embodiment, the present invention takes the form of a computer-program product that includes computer-useable instructions embodied on one or more computer-readable media.

Computer-readable media include both volatile and nonvolatile media, removable and nonremovable media, and contemplates media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions—including data structures and program modules—in a modulated data signal. The term “modulated data signal” refers to a propagated signal that has one or more of its characteristics set or changed to encode information in the signal. An exemplary modulated data signal includes a carrier wave or other transport mechanism. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

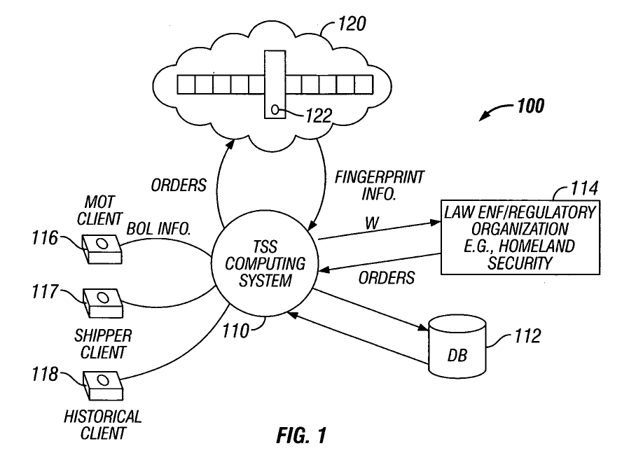

Exemplary embodiments of the present invention are disclosed in FIGS. 1 through 6. Referring first to FIG. 1, a schematic showing one embodiment of the computing system of the present invention is disclosed. A system 100 comprises several computing components. First, a Transportation Safety System (TSS) central computing arrangement 110 operates at the heart of the overall system 100.

TSS computing system 110 works with a database 112. Database 112 stores historical and current information in real time for later retrieval. In communication with system 110 are at least three interested organizations. These consist of: (i) a shipper/receiver of the freight or individuals in the case of people movement represented in system 100 by a client 118, (ii) a Mode of Transportation organization (MOT) represented in the system by an MOT client 116, (iii) a historical client 118 which stores historical information on utilizes the data in a historical and predictive way and this will be a commercial enterprise in and of itself, and (iv) a Regulatory/Enforcement group 114, which is also a client on the system. Other interested organizations could be added as well and still fall within the scope of the present invention.

These interested organizations are able to receive warnings (W), notifications, alerts, and other information and when required or from time to time enter handling orders to the computing system. The shipper/receiver client 117 of freight will normally be the entity to most likely provide BOL information. This may be done directly into TSS computing system 110, or conveyed first to MOT client 116 for introduction into the TSS computing system. In such a case, the MOT interested organization will communicate with database 112 regarding lading and vehicle identification, verification, sensing, detection, inspection, planning and operations connected with the moving of goods and people from origin to destination in a safe manner. Most typically, the flow of BOL information moves from shipper/receiver client 117 to TSS computing system 110. This communication between clients and TSS computing system 110 is of course a two-way process. Interested parties 116, 117, 118, and 114, are all able to access DB 112 through TSS computing system 110 at their leisure or to fulfill their needs. For example, inquiries may be made by commercial accounts on a real time basis at the discretion of the vender. Further, information may be saved by any of these clients for the purpose of generating and/or maintaining the DB 112.

TSS computing system 110 is also in communication with a detection location 120. Detection location 120 might be a point of entry into a particular geographic area, e.g., a port or border town on a highway, railroad border crossing. It also could be a checkpoint at some location in the transportation grid (e.g., highway system, railway system, airport, highway checkpoint). It could be managed by an independent agency which is also a client on the system 100 or by the MOT, shipper, or even the law enforcement/regulatory agency 114. In the disclosed embodiment, however, it is shown as being managed by and communicating with an application running on the TSS computing system 110 directly.

In one embodiment, each detection location 120 will include a battery of sensors 122. Battery 122 can take many forms which would all be included within the scope of the present invention. Some of the kinds of sensing devices that may be employed include audio, visual, smell activated, or thermal sensing devices. For example, sensors which detect surface acoustical waves might be used. Alternatively numerous other kinds of devices might be used. Sensors also exist which are able to electronically evaluate a whiff of air—a kind of electronic smell test, are also known. These devices could all be arranged in a manner consistent with methods known to those skilled in the art. The sensors could also be radiation, hot, cold, infrared, vibration, or other value detection devices.

These sensors could work in conjunction with a plurality of special seals employed on containers in the shipment. These seals would reveal any tampering. For example, they might transmit a signal of the container was opened in transit which, when detected by some form of sensing device would indicate that a container had been opened without authorization. These seals could also be adapted to signal other information about the contents of the container. For example, spoilage or a chemical spill. For security purposes, the seals once installed, could be configured to immediately contact law enforcement or other interested organizations for immediate response to any entry of the container. Upon breaking the seal, it could transmit signals giving container locations en route, entry location. The seal could also report damage control from shock or other unusual occurrences that would be of interest to the owner of the material or security concerns for those charged with that responsibility. Similar units which record vibrations are now used on high value cargo for recording transporting conditions in transit. It is within the skill of one in the art to adapt these conventional devices to enhance the data transmitted. Thus, the conventional detection devices could be easily altered to transmit other material information of interest, such as that discussed above. This would be one way to place into “bond” a shipment destined to or through another country.

Fingerprint information will be received from detection point 120 in real time. Information sensed will be dynamically transferred into the TSS computing system 110 so that a database may be created and maintained—database 112. Thus, database 112 may be accessed to obtain real time information regarding information transmitted to it from the detection points.

Database 112 will prove to be a tremendous resource. It will be accessible for the benefit to users of the overall system. Its contents include real-time information. Orders from the computing system are receivable by systems at the detection point 120 which will allow the users at detection point 120 to react to instructions by others, for example, law enforcement agencies. Priorities could also be set in place to accomplish more rapid response to dangerous situations. For example, the application running on TSS computing system 110 could include a process which causes priority to be given to any instance in which troubling readings are received from more than one sensor. The thinking being that two separate indications of danger validate each other. Because of the rapidity granted by automation, the response to such an indication could be expedited.

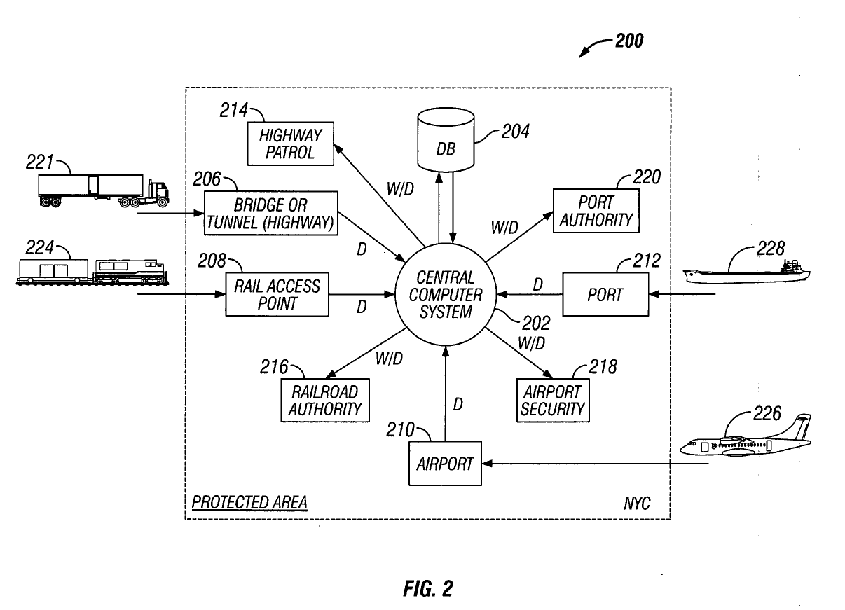

Another embodiment of the present invention is disclosed at FIG. 2. In that figure, a system for protecting a protected area 200 includes a central computer system 202 and a database 204. These components operate much in the same way as computing system 110 and database 112 in FIG. 1. In the FIG. 2 embodiment, however, the detection points are disclosed as being at multiple locations. These point of entry (POE) detection points are specified in FIG. 2 are merely examples, and should not be considered limiting. Other examples exist which would also fall within the scope of the present invention. The examples disclosed in FIG. 2 include a highway detection point at a bridge or tunnel 206, a rail access point 208 (which would be at the point the railroad tracks cross into the protected area), an airport 210, and a port 212. Each of these access points comprise major points of access for vehicle traffic. In other words, transportation gateways into the community. This might occur at the location in which a major highway comes into a city, a railroad station comes across a border, or an airport

In the preferred embodiment, though not shown in detail in FIG. 2, data will have been collected regarding each respective shipment before that shipment's arrival at one of the access points such as bridge 206, rail access point 208, airport 210, or port 212. This is necessary in order to adequately secure the entire protected area. In some embodiments, however, the initial data collection will be made at the access point, which is a point of entry into the area, or even at a detection point inside the protected area.

The process of the present invention should be employed such that all reasonable points of entry into the protected area would be covered by detection points like that at 120 in FIG. 1. Each detection point should include a battery of sensors, or some other kind of scenario enabling real time detection of potentially dangerous situations or items. It should be understood that the detection equipment is inherent in FIG. 2, though not shown.

At each of these access/detection points 206, 208, 210, and 212, one or more interested organizations will be associated therewith. As illustrated in the figure, a highway patrol agency 214 would likely be responsible for a bridge or tunnel on the highway 206. Similarly, a railroad authority 216 would be responsible for rail access point 208. An airport security office 218 might be responsible for securing airport 210. Likewise, port 212 might be secured by a port authority 220.

The above-described arrangements will be used to monitor shipments and other traffic by way of a plurality of motor vehicles 221, a plurality of trains 224, a plurality of ships in transit 228, and/or a significant amount of air traffic 226. Access/detection points 206, 208, 210, and 212 will effectively and thoroughly monitor all of the significant traffic into the protected area (the area used in this embodiment is disclosed as being New York City, but it will be apparent to one skilled in the art that the disclosed technologies would be applicable to any city, state, nation, region, or other area with borders and traffic access points). It should be noted that though all the examples of transporting mechanisms disclosed in FIG. 2 are vehicles of some kind, the scope of the present invention is not limited to any specific group of vehicles, or vehicles at all. For example, pipelines delivering products into a protected region could also be equipped with the devices of the invention described herein and still fall within the scope of the present invention.

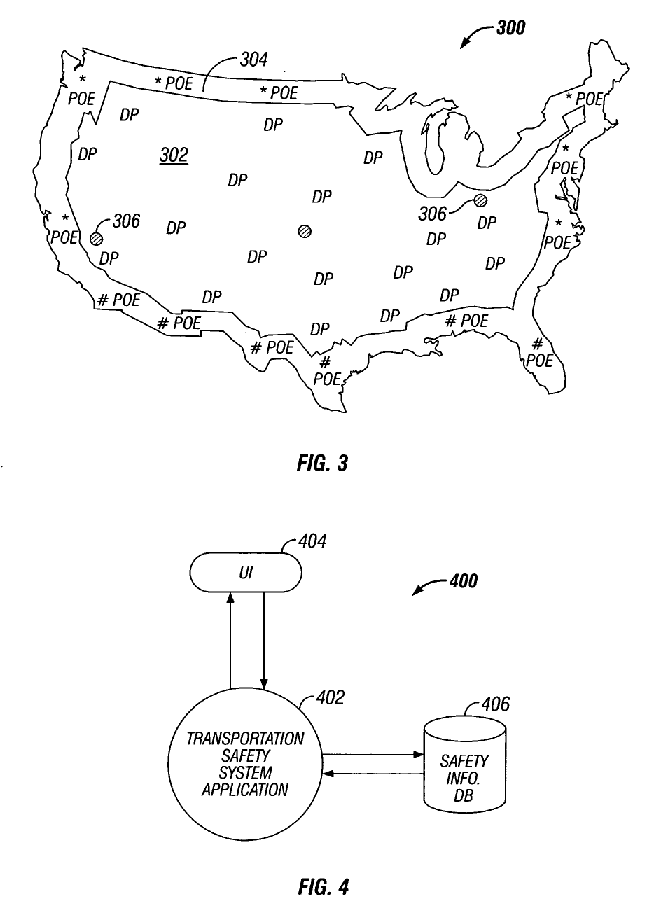

Referring now to FIG. 3, we see the principals of the present invention in use on a larger scale. In this figure it can be seen that a protected region 300, herein disclosed as being the United States, includes a protected border 304. Border 304 completely seals a protected interior region 302. Protected border 304 also includes a number of significant points of entry (identified as “POE”). The points of entry as disclosed in FIG. 3 have been greatly reduced in number for the purpose of creating a more manageable map. An actual system would likely include many more points of entry.

Each of these points of entry (POE) will be an access/detection point as described in the earlier figures. Other detection points (denoted as “DP” in FIG. 3) will be located within the interior region 302. These will be utilized as checkpoints as described in the process hereinafter.

Also shown in FIG. 3 are a number of interior points of entry 306. According to the present embodiment of the invention, these points 306 are airports. It is obvious that many more airports would exist. Again, the FIG. 3 map has been simplified so that it is more easily understandable. Each of the detection points noted at the points of entry (POE) and at the interior places denoted as DP will be used to make the protected region 300 more secure according to the following processes and procedures.

A process diagram 400 shown in FIG. 4 discloses the computing processes of the present invention. Referring to the figure, it may be seen that the transportation safety system comprises a computer application 402. Application 402 may be running on a server, a group of servers, or some other kind of computing hardware arrangement. It may also be run on a web server as part of a web accessed program which is accessed through a user's web browser. It could alternatively be utilized as part of an intranet arrangement. Regardless, the system comprises some sort of user interface 404. Interface 404 gives clients (both automated and human clients) access to the TSS application 402.

The TSS application maintains a database 406. This database 406 will be used to store and maintain safety information for the whole system. It will be evident to one skilled in the art that what is disclosed in FIG. 4 is oversimplified considering the magnitude of the system that would be required to employ the processes of the present invention on a large scale (e.g., nationwide or even worldwide). It is, however, illustrative of one embodiment which has been simplified to make the invention more easily understood. It will also be evident to one skilled in the art that database 406 would include numerous sub-databases devoted to specific data collected. Further, the system would likely involve the use of multiple physical data storage devices or systems. But for simplicity sake, only one database has been shown here.

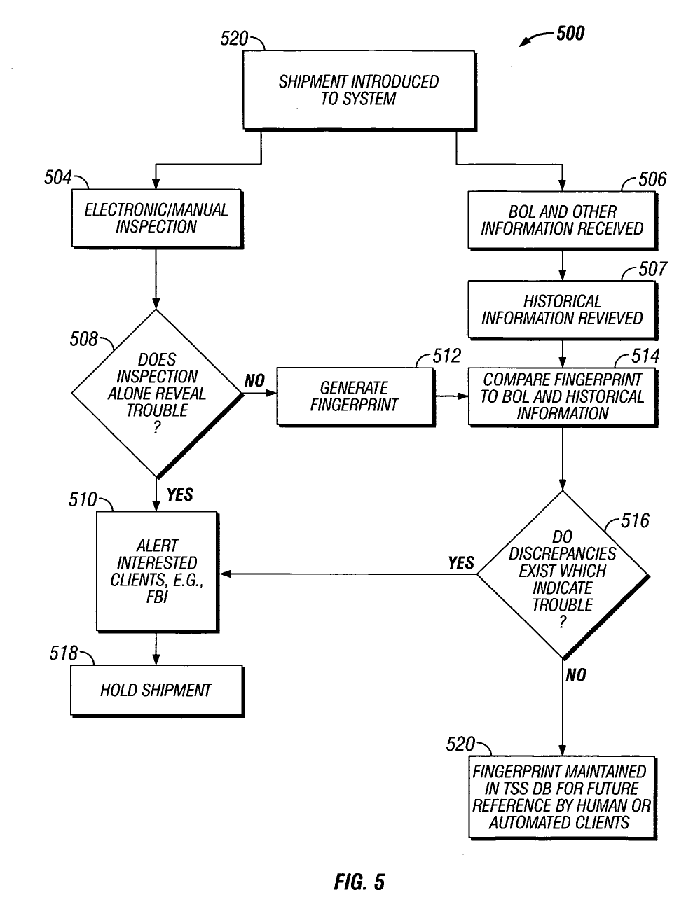

FIG. 5 discloses how a shipment is introduced into the transportation safety system. As already mentioned above, the introduction into the system should, in the preferred embodiment occur at some location outside the protected area. For example, the FIG. 5 process for a shipment originating from Indonesia and slated for shipment to New York City will occur in Indonesia. It must be performed before the shipment is dispatched so that threats can be identified before the shipment reaches a protected area (e.g., the United States), or at least upon reaching the border of the protected area. That way the shipment may be evaluated before its introduction.

FIG. 5 comprises a flow chart 500. Flow chart 500 is one embodiment of the present invention which is capable of introducing shipments into the system. This process is used to accomplish the safety, security, and other objectives of the present invention.

The process begins with a first step 502. Step 502 is where the shipment is first introduced into the system. This will normally involve the arrival or presence of the shipment at a location outside the protected area. For example, a ship is set for sail from a port in France (which is outside the protected area) into New York City (which is inside the protected area, e.g., the United States). It could also occur at a foreign airport for a flight headed for the U.S., a truck weigh station in Mexico for a shipment headed for Houston, or some other convenient time at which a shipment may be engaged before it's introduction into a protected area. (e.g., a tunnel through which trucks are driven into New York City, at an airport).

The introduction of step 502 could alternatively occur at the time the shipment-containing vehicle reaches a point of entry into the region. This would have the advantage of protecting the borders, but would have the disadvantage of failing to protect the point of entry itself.

Another alternative for step 502 is that it could occur at the time when a detection point is reached within the inside area of a protected region. For example, one of the detection points (DP) inside the protected area, such as those in inside area 302 in FIG. 3. This would provide security and safety from that point on in the shipment's journey, but would have the limitation that it would not be able to afford the benefits of the system before the shipment's introduction into the protected area.

Regardless, step 502 is the introduction of the shipment into the system. And preferably will occur before or simultaneous with the vehicle reaching the protected area.

After step 502, the process branches into two separate, and possibly continuously-ongoing processes. The first branch includes steps 504, 508, 510 and 512—the steps relating to the development of an electronic fingerprint. The second channel of the process involves step 506 and then meets up again with the first branch at a step 514.

With respect to step 504, an electronic and/or manual inspection of the shipment occurs. This mostly likely will include inspection of the vehicle or vehicles containing the shipment. Regardless of where the information is developed from, it will mostly involve combination of information sensed from a battery of sensors (see for example battery 122 in location 120 of FIG. 1). This sensor battery includes a plurality of sensing devices. These sensing devices might be thermocouples or other thermal sensing devices, surface acoustical wave sensors, video detection devices including infrared sensors, chemical sensors or digital smell detection devices, or numerous other kinds of digital sensing devices. One skilled in the art will recognize that these devices have been used elsewhere in the art for other purposes, and that one skilled in the art will know how to set up these sensors. The sensors will ideally be arranged so that they may detect visual, olfactory, audio, temperature, and other checks on the shipment while it is stopped at its origination point (e.g., Indonesia). Alternatively, the sensors could make an initial detection as it passes through in motion. This would enable inspection without having to stop.

The information obtained from the sensors is not limited to the cargo itself. It would, instead, likely include information regarding the MOT shipping vehicle (e.g., oil pressure, wheel temperatures).

Other information which might be included in the inspection information will be obtained manually. For example, an actual human might inspect the containers, or the places on the vehicle and enter certain conditions into a PC (such a PC might be located at a detection point 120 as shown in FIG. 1 or at one of the points of entry 206, 208, 210, or 212 in FIG. 2).

The results of this inspection are used to make a determination in step 508. This step involves taking the information entered in step 504 and either querying a database or making a manual determination of whether this information alone is indicative of some sort of trouble. Some examples of trouble might be an axle on a train overheating, a chemical detection which indicates hazardous chemicals that might be leaking, or olfactory detection which indicates the presence of humans (e.g. illegal immigrants) hiding in cargo. If such information reveals trouble in step 508, an interested party will be notified in a step 510. If the interested party (e.g., the FBI) determines that the situation warrants holding the shipment, that will take place at an optional step 518. Referencing FIG. 1 is helpful in understanding how this occurs. For example, if the alert is received by interested organization 114, for example Homeland Security, an order will be issued as shown in that figure. This order is received by the computing system 110 and then transmitted back to the location at which the shipment is scheduled to originate from (e.g., Indonesia).

If this occurs and the detain order is given, individuals at the origination point will, at the direction of the interested party, hold the vehicle (train) and not allow it to leave.

All of the above mentioned steps occur with such rapidity that the shipment process is not slowed. This is because of the automated systems used. These systems (e.g., workstations, application servers, etc.) are presently commercially available and their administration would fall within the knowledge of those skilled in the art. They will enable interested organizations to make a detain order within the required time period.

If there is no information in the inspection step 508 which, in and of itself, indicates an emergency, the process will, instead of initiating an alert, proceed to a step 512. Step 512 involves an electronic generation of what will be referred to repeatedly herein as a “fingerprint.” The fingerprint may include a large amount of information regarding the shipment. The information will include the digitally sensed characteristics of the payload—or of the vehicle itself. It may also include some or all of the manual information entered in step 504. The fingerprint will then be used to identify the proper status of the shipment, and to automatically learn if any troubling changes have occurred, e.g., terrorists have planted a biological weapon among the cargo.

Meanwhile, in the second prong of the process, at step 506, BOL information is received. The information will be received automatically or manually. The BOL information will most likely be entered by the MOT. Ideally, step 506 will occur prior to the receipt of the transported goods at origin, and in all cases prior to movement in the Protected Zone. This step will be incorporated as a standard operating procedure in the shipping process. Using FIG. 1 as an example, the step 506 entry of BOL would occur after received from shipper 117 and prior to or simultaneous with the receipt of the lading. The entry will involve detailed information regarding the cargo on board the vehicle. This cargo might be goods. It also might comprise humans if the shipper is, e.g., a commercial airline. Unlike conventional methods, however, the BOL information will be then conveyed into the TSS computing system 110 and utilized. The available information BOL from client 116 might already exist in the computer system having been established with the MOT and shipper/receiver or some other kind of client.

Other information may be received in a step 507. Step 507 involves the entry of historical information regarding the shipper. For example, the typical kinds of goods shipped, particulars regarding quantities. This historical information may be entered using a client 118 which has access to the shipper's historical information. Alternatively, the information could be entered by the same MOT client 116 as discussed in step 506. Regardless, this historical information is also entered into and maintained in database 112 which is maintained by computing system 110. The BOL and historical information entered in steps 506 and 507 will be used to detect irregularities which might present dangerous situations.

Once all of the information is assimilated in steps 506 and 507, it is used in a step 514 to compare to the fingerprint generated in step 512.

The contrast of values sensed in the electronic inspection step 504 and the values suggested as proper by the BOL and historical information will be used to make an important computer query. This query is made in a step 516. In step 516 the fingerprint generated in step 512 will be electronically compared with the information obtained from the BOL and PO in step 506. Any discrepancies might be indicative of trouble. For example, the presence of nitrates when the BOL information, obtained in step 506, does not include anything which would have nitrates as an ingredient. Those skilled in the art will recognize that nitrates may be an ingredient in explosives. Further, review of the historical information obtained in step 507 reveals no instances in which the particular shipper has delivered goods including nitrates in the past.

This electronic comparison of the fingerprint information versus the BOL and historical information occurs in a step 514. The information in the last paragraph would be an indication of danger which could indicate trouble.

In a step 516, an electronic determination is made as to whether the comparison reveals discrepancies which are indicative of trouble. Practically, this would most likely involve the use of look-up tables which include warning triggers. That is, certain discrepancies will be electronically flagged such that if they are present, application 402 will know that the abnormality warrants alerting the authorities. These step 516 discrepancies might indicate trouble, such as a terrorist threat, vehicle failure, chemical hazard concern, or a shortage in the quantity of a particular shipped good (indicating theft).

If any troublesome discrepancies exist, interested clients are immediately alerted in step 510. These clients may make a determination as to whether the shipment should be held, or if the warning was false. If the warning is valid, a hold shipment order may be issued in step 518, and the MOT held. Otherwise, the MOT will be allowed to leave for its destination, and in a step 520, the fingerprint is maintained in the transportation safety system database. The fingerprint may additionally be modified to incorporate information from the BOL and/or historical information obtained. Regardless, the fingerprint, BOL, and historical information are all maintained in database (112 in FIG. 1; 204 in FIG. 2; 406 in FIG. 4) for immediate reference.

References to the database may be made through a user interface (see UI 404 in FIG. 4) which is used to access the TSS application 402 in a user's web browser (not pictured). Additionally, automated clients may access application 402 through interface 404 to gain information out of database 406 as a matter of routine. Regardless, step 520, when repeated for numerous shipments, enables the development of a voluminous database including large quantities of electronic information. This information may be used to protect regions from possible terrorist threats, vehicle disasters, and other like occurrences. This information may also be sold to interested parties.

It should be realized that the process disclosed in the flow chart 500 should be instituted such that it would automatically occur with respect to any shipment introduced into the system. For each such shipment introduced, all of the fingerprint information would be maintained within the database (database 112 in FIG. 1, database 204 in FIG. 2, database 406 in FIG. 4).

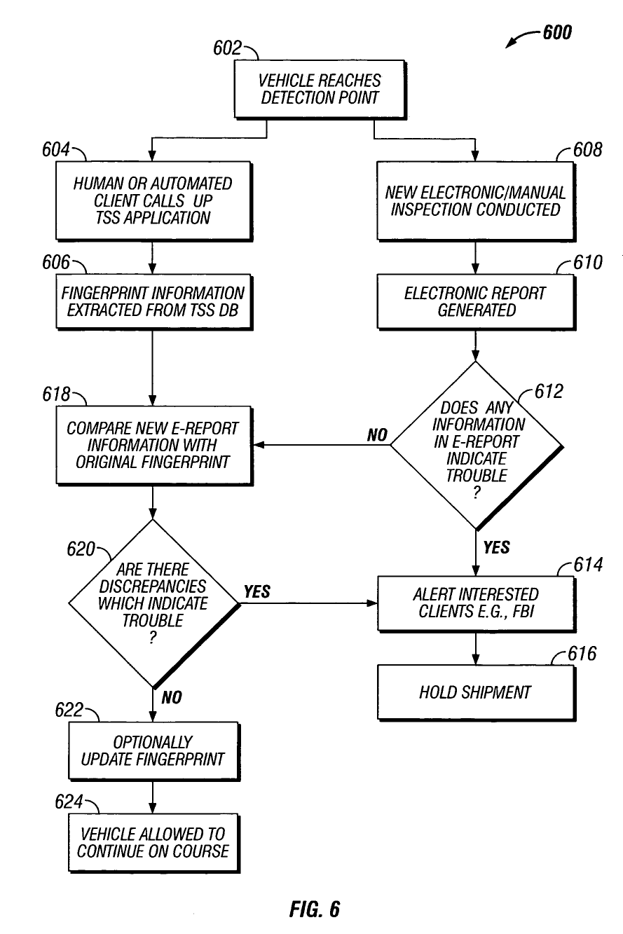

FIG. 6 discloses how the process would work at each point of entry (e.g., labeled POE in FIG. 3) into the protected area and at each detection point (e.g., labeled as DP in FIG. 3). It will be recognized that most points of entry are on the border of the FIG. 3 with the exception being airports, which could be located internally. The detection points are typically located in an inner region 302 of the protected area (the United States) disclosed in FIG. 3.

Initially, in a first step 602, the vehicle reaches the point of entry or DP. This shipment will have already been introduced into the system in the process described in FIG. 5. Hopefully at a location outside the protected area. Because of this, it will already have a fingerprint associated with it which includes the inspection information of step 504, and also may include the BOL and historical information of step 506. This already-stored information having already been recorded at the introduction point according to the process of FIG. 5 is used by the FIG. 6 process to avoid dangerous events.

To do this, in a step 604, a manual or automated client calls up the TSS application via UI 404. Most likely this will occur using an automated client located anywhere on the network. It might, however, involve a human user opening up the application in his or her web browser on a work station, if the application is a web application. Once application 402 has been called up, in a step 606, the fingerprint information is extracted from the TSS database for use in the process.

At the same time, in a different track of the process, a new electronic and possibly a manual inspection is conducted at the detection point in a step 608. The step 608 inspection is somewhat similar to the inspection of step 504 in the FIG. 5 process. It may comprise a completely electronic inspection using a battery of sensors, or involve a combination of automated and manual detection operations. For example, there is likely to be a battery of sensors set up at the detection point that will help accomplish this step. Additionally, workers could be stationed and positioned to be able to inspect the cargo and transportation device so after this in step 610 an electronic report is generated. The electronic report of step 610 would include the information obtained by the sensor bank in any manual inspection results. The report is then incorporated into an electronic format which is readily usable (e.g., placed into XML files).

Once this report has been generated, it is accessed by the TSS application 402 and evaluated for any irregularities that might suggest trouble (for example, an act of terrorism). This may be performed by querying the data files in the report for predetermined values or properties which suggest trouble. For example, the application will be able to identify a reading from a sensor that would indicate a hazardous chemical spill in one car of the train. Certain levels of a particularly dangerous chemicals will be known to the application and if the readings exceed certain values, an abnormality will be known.

In such cases, when a danger has been identified in step 612, a step 614 will alert interested clients (e.g., highway patrol 214, railroad authority 216, airport security 218, port authority 220, Homeland Security, FBI, ATF, local law enforcement) of the situation. If this interested client believes that the alert warrants, it will initiate a hold shipment order in a step 616. This belief, preferably is developed using artificial intelligence. For example, the application may know to immediately identify the FBI in the case that a reading from a sensor indicates the possibility of anthrax in one of the train cars. No human is needed to make this determination. This eliminates errors, and also enables the execution to be almost instantaneous. If the MOT is at a point of entry, this instantaneousness will enable the detain order to go out in enough time to prevent the shipment from entering into the protected area. In the case that the shipment is at a detection point in the interior region of the protected area, the shipment may be immediately detained and law enforcement dispatched.

If no such emergency is evident, the process proceeds to a step 618. This step introduces the fingerprint information generated in FIG. 5 into the FIG. 6 process. Step 618 compares the FIG. 5 fingerprint to the values detected in the electronic report of step 612. The application evaluates any differences detected for indications of irregularities which indicate trouble. For example, the olfactory detectors at one of the detection points (DP) might detect human cargo, whereas the fingerprint information discloses only the shipment of goods. This would indicate the presence of at least one stowaway in the transportation vehicle. This would not have automatically triggered an alert in step 612, because the presence of a human on the shipment may not have been pre-arranged as a danger in the application. It is, however, and issue when compared with the fingerprint which shows that no human was included with the cargo when it was introduced into the system in FIG. 5. Thus, the comparison provides an additional level of protection. Step 618 provides a short of grounding for the dynamic process. A standard by which an electronic comparison may be made and acted on.

Once the comparison has been made in step 618, a step 620 comprises a determination of whether any discrepancies detected suggest trouble. Referring to the stowaway hypothetical above, if the presence of a human with the all-goods shipment is pre-arranged as an event that warrants a warning going out, the process will proceed to step 614 in which the appropriate client, for example ATF, is contacted.

If there are no such discrepancies, the process proceeds to step 622 in which the fingerprint may optionally be updated. The application may allow such updates to include new information obtained from the new electronic manual inspection in step 608 which has been verified safe. This step is optional in that in some situations it will be desirable to stick with the standard fingerprint throughout as the vehicle approaches the numerous detection points possible in the protected area. In other situations, it may be desirable to update the fingerprint so that the same false alerts identified by the law enforcement agencies aren't repeated over and over again as the shipment travels through numerous detection points. For example, the FBI may determine electronically that a reading on a sensor for anthrax is false, it may want to alter fingerprint after inspection so that the same factors that caused the initial false reading do not reoccur as false alerts in the future.

After all of the other steps in FIG. 6 have been completed, the process concludes with a step 624. In a step 624, once the shipment is cleared as being nondangerous, it is allowed to continue on course.

It is important to note that though FIG. 6 refers to only one model for procedures at each detection point (or point of entry), that the vehicle would obviously travel between numerous detection points as it travels around in a protected area. For each of these stops, the FIG. 6 process is repeated. This ensures that if some danger arises in transit (for example, a wheel bearing is near failure as evidenced by overheating or vibrations or sound) that it will be detected (sensed) by the new electronic inspection at the next detection point. And if the readings sensed at that point are not indicative in and of themselves, a comparison between the fingerprint and the inspection results might reveal trends between checkpoints which suggest a gradual failure (e.g., gradual temperature increases). In such cases, application 402 will be predisposed to identify these trends so that potential failures may be identified prior to imminent failure.

As can be seen, the present invention and its equivalents are well-adapted to provide a new and useful method of monitoring and managing transportation. Many different arrangements of the various components depicted, as well as components not shown, are possible without departing from the spirit and scope of the present invention.

The present invention has been described in relation to particular embodiments, which are intended in all respects to be illustrative rather than restrictive. Alternative embodiments will become apparent to those skilled in the art that do not depart from its scope. Many alternative embodiments exist but are not included because of the nature of this invention. A skilled programmer may develop alternative means of implementing the aforementioned improvements without departing from the scope of the present invention.

It will be understood that certain features and subcombinations are of utility and may be employed without reference to other features and subcombinations and are contemplated within the scope of the claims. Not all steps listed in the various figures need be carried out order described.

The invention claimed is:

1. One or more computer-readable media, having computer-usable instructions embodied thereon for performing a method comprising:
receiving an original data set from a client, said original data set including information regarding a shipment being made from an original location by a mode of transportation (MOT);
maintaining said original data set in a database;
receiving new data from a first sensor at a detection-point location;
comparing said new data with said original data set;
determining whether said comparing step reveals trouble; and
automatically notifying one of an interested person and entity if said determining step reveals trouble.

2. The one or more computer-readable media of claim 1 wherein said receiving said original data set comprises:
sensing a value of an original property of said shipment using an origination sensor at said original location; and
incorporating said value into said original data set.

3. The one or more computer-readable media of claim 1 wherein said receiving said original data set comprises:
manually entering a value of an original property of said transportation shipment; and
incorporating said value into said original data set.

4. The one or more computer-readable media of claim 1 wherein said receiving said original data set comprises:
receiving bill of lading information regarding said shipment.

5. The one or more computer-readable media of claim 1 wherein said receiving said original data set comprises:
receiving historical information regarding a shipper of said shipment.

6. The one or more computer-readable media of claim 1 wherein said step of receiving new data from a sensor at detection-point location method further comprises:
including at least one of olfactory information, visual information, sound information, and temperature information in the received information.

7. The one or more computer-readable media of claim 1 wherein said step of receiving new data from a sensor at detection-point location method further comprises method further comprises:
using a plurality of sensors to detect information at said detection-point location.

8. A transportation safety system, comprising:
an introduction station, said station being located outside a protected geographical area, said station further including a first plurality of sensors, said first plurality of sensors being adapted to receive at least one of visual, temperature, audio, olfactory, and vibration information from a shipment upon said shipments introduction into said protected geographical area;
a detection point located within said protected geographical area, said detection point including a second plurality of sensors, said second plurality of sensors being adapted to receive at least one of visual, temperature, audio, olfactory, and vibration information from the shipment;
a computing system including a database, said computing system adapted to compare said information from said first plurality of sensors with said information received from said second plurality of sensors and employ said comparison for safety purposes.

9. The system of claim 8 wherein said computing system is adapted to automatically contact an interested organization if danger is indicated in said comparison.

10. The system of claim 9 wherein said introduction point is on or about a highway at a location on our about a border of said protected area.

11. The system of claim 10 wherein said detection point is located on or about a highway at a location inside said protected area.

12. The system of claim 11 wherein said interested organization comprises a highway patrol.

13. The system of claim 9 wherein said introduction point is on or about a railway at a location on our about a border of said protected area.

14. The system of claim 13 wherein said detection point is located on or about a railway at a location inside said protected area.

15. The system of claim 14 wherein said interested organization comprises a railroad authority.

16. The system of claim 9 wherein said introduction point is on or about an airport inside said protected area.

17. The system of claim 16 wherein said interested organization comprises an airport authority.

18. The system of claim 9 wherein said introduction point is on or about a sea port on our about a border of said protected area.

19. The system of claim 19 wherein said interested organization comprises a port authority.
